(19) United States
(12) Patent Application Publication
(10) Pub. No.: US 2014/0099129 A1
(43) Pub. Date: Apr. 10, 2014

(54) NETWORKS AND METHODS FOR RELIABLE TRANSFER OF INFORMATION BETWEEN INDUSTRIAL SYSTEMS

(71) Applicant: ALSTOM Technology Ltd, Baden (CH)

(72) Inventor: Regis TARDY, Villejust (FR)

(73) Assignee: ALSTOM Technology Ltd, Baden (CH)

(21) Appl. No.: 14/046,076

(22) Filed: Oct. 4, 2013

(30) Foreign Application Priority Data
Oct. 5, 2012 (EP) 12290338.8

(51) Int. Cl. H04B 10/80

(52) U.S. Cl. CPC H04B 10/801
USPC 398/164

(57) ABSTRACT

A communication network and method for transfer of information are disclosed. The communication network includes plurality of industrial systems. Each system includes I/O board including I/O modules, at least one of an optical emitter and an optical receiver, and a processing module. The processing module and the I/O board generate an optical signal corresponding to information and a Cyclic Redundancy Check (CRC) information. The network includes a first optical bus and a second optical bus coupled with the I/O boards for transferring the optical signal and complement of the optical signal between the systems.

### CROSS-REFERENCE TO RELATED APPLICATIONS

This application claims priority to European application 12290338.8 filed Oct. 5, 2012, the contents of which are hereby incorporated in its entirety.

### TECHNICAL FIELD

The present disclosure relates to methods and systems for reliable transfer of information between industrial systems using optical network.

### BACKGROUND

Industrial setup may have a variety of systems such as control stations, machineries, and other components interconnected in a network. The network is used to transfer variety of information such as information related to process flow, telemetry information, and other monitoring and control information between the systems. Such systems of the industrial setup may be located at distance upto several kilometers (km) from each other.

In an exemplary scenario, communication channels, such as Ethernet based channels, are used for the transfer of the information between various systems of the industrial setup, through physical wires, such as copper or any other metal wire. However, such channels have a certain degree of latency, and are non-deterministic when the traffic of information increases between the systems. Further, such channels utilize addition network components and have limitation in terms of speed, latency, redundancy and security.

In some other exemplary scenarios, wireless transfer of information may also be utilized. However, apart from a costly implementation of wireless components, noise interference between various radio wave signals and in-circuit electrical signals becomes challenge in a wireless communication in industrial systems. Under these scenarios, there is increased usage of optical transmission of information that is typically free from electromagnetic noise, high in speed and low in loss for signal transmission. However, even in optical transmission of information, reliable, error free, and deterministic transfer of information are still important objectives in a network of the industrial systems.

### SUMMARY

The following presents a simplified summary of the disclosure in order to provide a basic understanding of one or more aspects of the disclosure. This summary is not an extensive overview of the disclosure. It is intended to neither identify key or critical elements of the disclosure, nor to delineate the scope of the present disclosure. Rather, the sole purpose of this summary is to present some concepts of the disclosure in a simplified form as a prelude to the more detailed description that is presented hereinafter.

An object of the disclosure is to provide a fast and reliable transfer of information between systems deployed in industrial plants and processes. Another object of the disclosure is to provide a secure transfer of information between the systems and precluding need for change of a communication protocol while transfer of the information. Another object of the disclosure is to provide the transfer of information that is deterministic from a system transmitting the information to a system receiving the information.

The above noted and other objects may be achieved by a communication network for transfer of information between industrial systems, the communication network comprising: a plurality of industrial systems, each system of the plurality of industrial systems comprising: at least one of an optical emitter and an optical receiver, an Input/Output (I/O) board comprising at least one I/O module; and a processing module coupled with the I/O board, the processing module and the I/O board configured, at least to, generate an optical signal corresponding to an information and a Cyclic Redundancy Check (CRC) information associated with the information; a first optical bus coupled with the at least one of an optical emitter and an optical receiver of one or more pairs of systems of the plurality of industrial systems for transferring the optical signal between the one or more pairs of systems; and a second optical bus coupled with the at least one of the optical emitter and the optical receiver of the one or more pairs of systems for transferring a complement of the optical signal between the one or more pairs of systems.

In an aspect, the processing module includes a CRC generator configured to generate the CRC information, and a bus information module configured to generate the bus information based on a master optical bus from the first optical bus and the second optical bus. In an aspect, the processing module is also configured to determine a reliable receipt of the information based on matching a signal received from the first optical bus and a signal received from the second optical bus, and a CRC algorithm. In an example, the first optical bus and the second optical bus are optical fibre cables, and may be serial buses. The first optical bus and the second optical bus are arranged in a parallel configuration. In an aspect, at least one of the plurality of industrial systems comprises a memory module to store the information. In an aspect, I/O modules of each of the at least one I/O module are coupled through a copper wire.

The above noted and other objects are also achieved by a method for communicating information between a plurality of industrial systems, the method comprising: generating an optical signal corresponding to an information and a Cyclic Redundancy Check (CRC) information associated with the information; generating a complement of the optical signal; transmitting the optical signal in a first optical bus from a first system to a second system of the plurality of industrial systems; transmitting the complementary optical signal on a second optical bus from the first system to the second system, the second optical bus being in parallel with the first optical bus and the first optical bus and the second optical bus coupled with an I/O board of the first system and an I/O board of the second system.

In an aspect, the method further includes receiving a signal transmitted from the first optical bus and a signal transmitted from the second optical bus at the second system, and determining a reliable receipt of the information based on matching the signal received from the first optical bus and the signal received from the second optical bus, and a CRC algorithm. In an aspect, the optical signal comprises a bus information based on a master optical bus from the first optical bus and the second optical bus.

Advantageously, technical aim of various embodiments of the devices and methods is to provide a reliable and fast transfer of information between industrial systems. For instance, the communication speed may be upto 10 Giga bits (Gbits) per second due to the optical transmission channels utilized for performing the communication. Various embodiments use two parallel optical fibre buses for the transfer of information from the first system to the second system. The first optical fibre bus is used to transfer an optical signal for the information (that is to be transferred), the CRC information corresponding to the information and a bus information representing a master bus from the first optical bus and the second optical bus. The second bus of the pair is used to transfer a complement of the optical signal. At the optical receiver in the second system, reliability of the information transfer may be determined by matching signals received from both the buses, so as to, whether these are complement to each other or not. Further, due to the usage of the high speed optical transmission channels, the information is deterministic from the optical emitter to the optical receivers associated with I/O boards, even at a considerable length connection (for example, more than 10 km). For instance, a deterministic parameter may be approximately 0.5 nano-seconds (ns). Various embodiments of the present disclosure may be easy to implement, and may be used in industrial applications, such as nuclear applications. Various embodiments of the present disclosure provide coupling the first and second optical buses from the optical emitter of the first system to the I/O board of the second system, and the optical signals are transferred from the optical emitter of the first system to the I/O board of the second system in compliance with a single protocol. As any protocol conversion is not required, such transfer of information is protected from spying, and such other security threats.

Further objects, advantages and features of the present disclosure will be apparent from the following detailed description and claims.

### BRIEF DESCRIPTION OF THE DRAWINGS

For a more complete understanding of example embodiments of the present disclosure, reference is now made to the following descriptions taken in connection with the accompanying drawings in which:

FIG. 1 illustrates an exemplary block diagram representation of a communication network for transfer of information, in accordance with an exemplary embodiment of the present disclosure;

FIG. 2 illustrates an exemplary block diagram representation of a communication network representing industrial systems and optical bus connections between them, in accordance with another exemplary embodiment of the present disclosure; and

FIG. 3 is a flowchart depicting a method for transfer of information between a plurality of industrial systems, in accordance with an exemplary embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, structures and devices are shown in block diagrams form only, in order to avoid obscuring the disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Broadly, embodiments of the present disclosure provide devices and methods for reliable and fast transfer of information between a plurality of industrial systems. Various embodiments use transfer of information through an optical communication network to achieve a fast data transfer, for example, upto 10 Giga bits (Gbits) per second. Various embodiments use a pair of optical fibre buses for the transfer of information from a system to another system of the plurality of industrial systems. A first bus of the pair is used to transfer an optical signal for the information (that is to be transferred, also referred to as ‘actual information’ in the description), additional information and a cyclic redundancy check (CRC) information corresponding to the information. The second bus of the pair is used to transfer a complement of the optical signal. At an optical receiver at the another system, reliability of the information transfer may be determined by matching signals received from both the buses whether the signals are complement to each other or not. Further, CRC information may further be used to detect any error in the receipt of the information at Input/Output (I/O) board of a system receiving the information. Various embodiments of the present disclosure provide coupling the optical buses from an optical emitter of the system upto an Input/Output (I/O) board of the another system, and the optical signals are transferred from the optical emitter to the I/O board in compliance with a single protocol. As any protocol conversion is not required, such transfer of information is protected from spying, and other security threats.

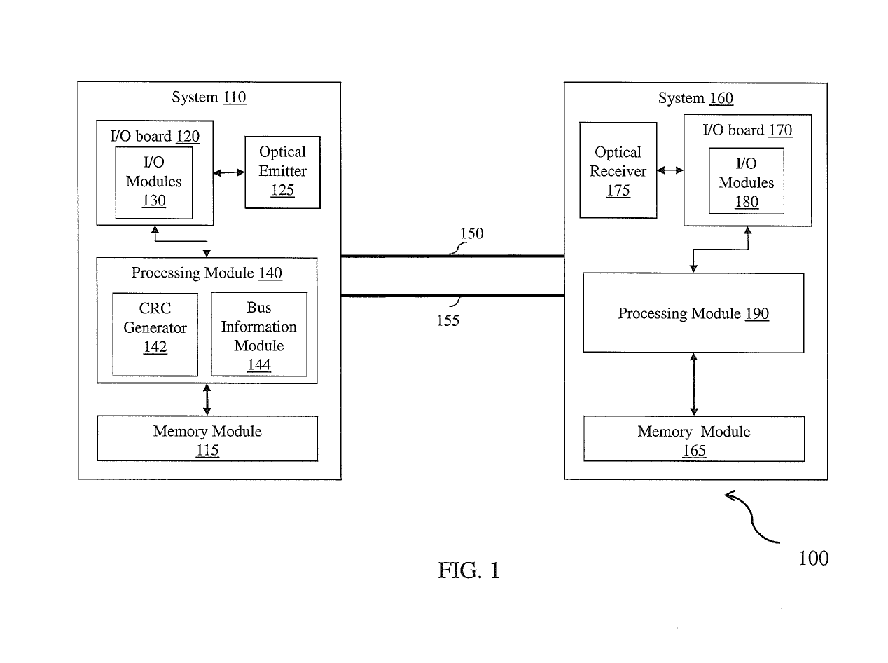

Referring now to FIG. 1, there is shown a block diagram representation of a communication network 100, in accordance with an exemplary embodiment of the present disclosure. The exemplary communication network 100 is illustrated for the sake of describing communication between a pair of industrial systems, for example, a system 110 and a system 160. Only two systems 110 and 160 are shown for the description purposes, and in actual setup, many more such systems may be present in the network 100. Further, it should be understood that the network 100 may include a variety of components for performing communication, and only those components are shown that are relevant for the description of various embodiments of the present disclosure. With reference to the FIG. 1, transfer of the information from the system 110 to the system 160 is described.

Examples of the information (that needs to be transferred from the system 110 to the system 160) may non-exhaustively include process flow information, telemetry information, and other monitoring and control information in industrial applications. Examples of the systems 110 and/or 160 include, but are not limited to, variety of electronic devices in power plants (for fuels types, such as hydro, nuclear, thermal, renewable, wastes, and the like), grid, transport, mining plants, plants related to petro-chemical industrial applications, ore, fuels, paper, agro-food, mechanics, avionics, and the like. For instance, some examples of the systems 110 and 160 may include servers and other data repositories, buffers, repeaters, amplifiers, Distributed Control Systems (DCS), controllers, regulators, monitoring and diagnostic products, power electronic products, Supervisory Control and Data Acquisition (SCADA), controllers, electronic relays, protection products, measurement devices and communication devices.

Each of the systems 110 and 160 may include Input/Output (I/O) boards. These I/O boards of the systems 110 and 160 may include I/O modules and components for providing and receiving information from transmitters and/or receivers, so as to, perform signal transfer between the systems 110 and 160. The I/O boards may be embodied in at least one of a backplane of the systems 110 and 160, a Field Programmable Gate Array (FPGA), an Application Specific Integrated Circuit (ASIC), a System on Chip (SOC), a Micro-controller Unit (MCU), a Digital Signal Procession (DSP), an Electrically Programmable Logic Device (EPLC), Complex Programmable Logic Device (CPLD) configured in the systems 110 and 160.

Some exemplary I/O boards (for example, I/O boards 120 and 170) are shown in the systems 110 and 160 for the purposes of the present disclosure. The system 110 includes a transmitter (for example, an optical emitter 125) that may generate optical signals corresponding to electrical signals. The optical emitter 125 is configured to generate optical signals corresponding to the information that is to be transferred from the system 110 to the system 160. The system 160 includes an optical receiver 175 that is configured to receive the optical signals. The I/O boards 120 and 170 include I/O modules 130 and 180, respectively. It should be noted that the system 110 may also include an optical receiver similar to the optical receiver 175 and the system 160 may also include an optical emitter similar to the optical emitter 125 for transferring information from the system 160 to the system 110, and these components are not shown for the sake of brevity of this description. The I/O modules 130 and 180 are generic and allow different I/O module types to be mounted on a same base/plane, and are configured to provide the information (for example, the electrical signals) to be sent through the optical emitter 125, or to receive the information (for example, the electrical signals corresponding to the information) from an optical receiver, such as the optical receiver 175.

In an example, the network 100 includes a pair of optical buses (150, 155) for the transfer of the optical signals corresponding to the information between the systems 110 and 160. In an example, the optical buses 150 and 155 are serial buses and configured in parallel to each other. Examples of the optical buses 150 and 155 may include, but are not limited to, Optical Fibre Cable (OFC). The optical buses 150 and 155 may be coupled with the systems 110 and 160 for the transfer of the information between the systems 110 and 160. For instance, the optical buses 150 and 155 may be coupled with the systems 110 and 160 such that optical signals from the optical emitter 125 may be transferred to the optical receiver 175. As the processing modules 140 and 190 are coupled with the I/O boards 120 and 170, the information is transferred from the I/O board 120 (the emitter 125) to the optical receiver 175 of the I/O board 170 in compliance with a single protocol.

In various examples, the optical bus 150 (a first optical bus) is used to transfer an optical signal corresponding to the information (for example, the actual information that needs to be transferred), additional information and CRC information. In such examples, the optical bus 155 is used to transfer a complement of the optical signal corresponding to the information, the additional information and CRC information. For instance, the optical signal transmitted on the bus 155 is complement of the optical signal transmitted on the optical bus 150. As such, the optical signals transferred on the buses 150 and 155 are complementary, it may allow to crosscheck that the optical signals are correctly received at the optical receiver 175. In an embodiment, a bus information may also be transferred alongwith the CRC information, where the bus information represents an information of a master bus among the buses 150 and 155. For example, the bus 150 may be a master bus that is utilized to transfer information corresponding to the actual information, as the actual information may be received from signals received from the bus 150, at the optical receiver 175. The actual information is received after validation of the CRC and the complementary check for the information received from the master bus 150, by the processing module 190.

Each of the systems 110 and 160 may include processing modules for controlling the generation and/or transfer of optical signals that may be transmitted and/or received on the buses 150 and 155. For instance, a processing module 140 in the system 110 includes components for controlling the generation and/or transfer of the optical signals to be transferred over the buses 150 and 155. Examples of the processing module 140 may include a coprocessor, a microprocessor, discrete components, a micro-controller, a digital signal processor (DSP), processing circuitry with or without an accompanying DSP, or various other processing devices including integrated circuits such as, an ASIC, an FPGA, an EPLD, CPLD, an MCU, an SOC, or the like.

The processing module 140 may include a CRC generator 142 and a bus information module 144. The CRC generator 142 is configured to generate CRC information (for example, checksums) that is added with the actual information in compliance with an optical communication protocol. In an example, the optical signal corresponding to one or more CRC bits, the actual information, the additional information and a master bus information bit may be transferred in compliance with the optical communication protocol. In an example, the bus information module 144 is configured to generate a bus information bit, for example, an information bit representing a master bus among the buses 150 and 155. The processing module 140 is configured to provide the actual information alongwith the additional information, the CRC information and the bus information to the I/O board 120. In an example, the optical emitter 125 may generate an optical signal corresponding to the information, the additional information, the CRC information and the bus information. The optical signal is provided to the bus 150 for transferring the optical signal to the I/O board 170 of the system 160. In an example, a compliment of the optical signal is also generated by the optical emitter 125, and the complementary optical signal is provided to the bus 155 for transferring the complementary optical signal to the I/O board 170.

It should be noted that at any time instant, the optical signal (that are received at the I/O board 170) may represent a set of the actual information, the additional information, the CRC information and the bus information for the master bus. Similarly, at any time instant, the complementary optical signal (that is received at the I/O board 170) represents a set of the complement of each of the actual information, the additional information, the CRC information and the master bus information.

In an example embodiment, the system 160 includes a processing module 190 that is configured to determine reliability of the receipt of the information by the optical receiver 175. For instance, a reliable information transfer may be determined by matching the signals received from the buses (150 and 155), so as to, determine whether the received signals are complement to each other or not. In an example, the optical receiver 175 converts the optical signal received from the bus 150 into a first received signal (in electrical form), and converts the complementary optical signal received from the bus 155 into a second received signal (in electrical form). The processing module 190 is configured to determine whether the first received signal and the second received signal are complement to each other to determine the reliability of the receipt of the actual information at the system 160. Further, the processing module 190 is configured to use the CRC information to detect any error in the receipt of the information at the system 160, using a CRC algorithm. Examples of the processing module 190 may also include a coprocessor, a microprocessor, discrete components, a micro-controller, a digital signal processor (DSP), processing circuitry with or without an accompanying DSP, or various other processing devices including integrated circuits such as, an ASIC, an FPGA, an EPLD, CPLD, an MCU, an SOC, or the like.

It should be noted that system 110 may also include an optical receiver such as the optical receiver 175, and the system 160 may also include an optical emitter such as the optical emitter 125, so as to perform transmission of information from the system 160 to the system 110. The processing module 140 is also configured to determine reliability of receipt of the information by the optical receiver. Similarly, the processing module 190 in the system 160 includes components for controlling the generation and/or transfer of the optical signals to be transferred via the buses 150 and 155. For instance, the processing module 190 may include a CRC generator such as the CRC generator 142 and a bus information module such as the bus information module 144, so as to perform transmission of the information from the system 160 to the system 110.

In an example, the systems 110 and 160 include memory modules to store the information that is to be transferred and/or received. For instance, the system 110 includes a memory module 115 for storing the information. The information stored in the memory module 115 may be provided to the I/O module 130 based on instructions received from the processing module 140. Further, the system 160 includes a memory module 165 to store the actual information received at the system 160. The memory modules 115 and/or 165 may be non-volatile memories. Some examples of the non-volatile memories may include, but are not limited to, programmable memory, erasable programmable memory, electrically erasable programmable memory, flash memory, hard disk, magnetic memory, any new non-volatile technologies and the like. In some examples, the memory modules 115 and/or 165 may also be volatile memories, such as Random Access Memory (RAM), Dynamic Random Access Memory (DRAM), Static Random Access Memory (SRAM), and the like. The CRC information and the bus information may be stored in additional buffers/storages devices, or in the memory module 115.

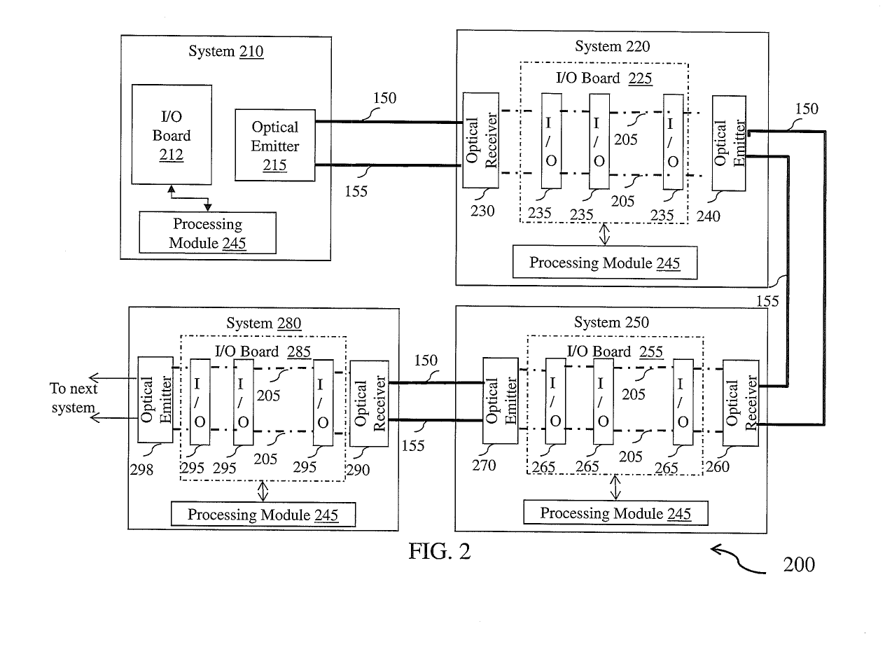

FIG. 2 illustrates a block diagram representation of a communication network 200 illustrating communication between various systems (210, 220, 250 and 280). Optical signals are transmitted between the systems 210, 220, 250 and 280 on a pair of optical buses, such as the buses 150 and 155. In the examples representation of FIG. 2, transfer of optical signals is described from the system 210 to the system 220, from the system 220 to the system 250 and thereafter from the system 250 to the system 280, and such description/representation should be construed as merely for the exemplary purposes, and should not be considered as limiting to the scope of the present disclosure. Each of the system 210, 220, 250, and 280 include a processing module 245. The processing module 245 may be an example of the processing modules 140 and/or 190. The processing module 245 includes components for controlling the generation and/or transfer of the optical signals to be transferred over the buses 150 and 155 between one or more pairs of the system 210, 220, 250 and 280. The processing module 245 is also configured to determine reliability of receipt of the information by an optical receiver of the corresponding system.

As shown in the exemplary embodiment of FIG. 2, the system 210 includes an I/O board 212. The I/O board 212 is configured to provide information (that is to be transmitted from the system 210) and additional information (for example, the CRC information and the master bus information) to an optical emitter 215. The optical emitter 215 is configured to generate optical signals for transferring via the buses 150 and 155. The optical emitter 215 may be an example of the optical emitter 125. The optical emitter 215 is configured to generate the optical signal corresponding to the information, the additional information, the CRC information and the bus information for the master bus among the buses 150 and 155. As explained in reference to FIG. 1, one of the pair of optical buses 150 and 155, for instance, the bus 155 may be a redundant bus. In certain embodiments, the optical signal is transmitted on the bus 150, and a complementary optical signal is transmitted on the bus 155. Herein, the optical signal corresponding to each of the information, the additional information, the CRC information and the bus information is termed as a ‘first optical signal’, and the complementary optical signal corresponding to each of the information and the additional information is termed as a ‘second optical signal’. In an example, if an information bit is ‘1’, the first optical signal corresponding to bit ‘1’ is transferred on the bus 150 and the second optical signal corresponding to bit ‘0’ is transferred on the bus 155. Such complimentary transmission of the information on the buses 150 and 155 may allow for crosschecking whether the information is received correctly at a receiving system (for example, at the systems 220, 250 and 280), as the bits received from both the buses 150 and 155 should be complementary to each other, so as to determine a correct receipt of the information. It should be understood that at the receiving system, the actual information may be retrieved based on the optical signals received by any of the buses 150 and 155 based on the bus information of the master bus among the buses 150 and 155.

The buses 150 and 155 are coupled to the optical emitters/optical receivers (that are coupled with the I/O boards) of a pair of systems, so as to transmit/receive the first and second optical signals. For instance, the buses 150 and 155 are coupled between the I/O board 212 of the systems 210 and the I/O board 225 of the systems 220 for transfer of the information between the systems 210 and 220. As shown in FIG. 2, the system 220 includes an optical receiver 230 configured to receive the first and second optical signals (corresponding to the information provided by the I/O board 212) from the buses 150 and 155, respectively.

The optical receiver 230 converts the first and second optical signals into the first and second electrical signals. The optical receiver 230 is coupled with the plurality of I/O modules 235 through wired connection, such as a copper wire 205 or any other metallic wire. It should be noted that the actual information may be retrieved from any of the first electrical signal and the second electrical signal by the I/O modules 235. As described in reference to FIG. 1, reliability of receipt of the information may be checked by determining whether the first electrical signal and the second electrical signal are complementary. The system 220 includes the processing module 245 to check whether the actual information is received correctly by the I/O board 225 by using the CRC algorithm.

The system 220 may further include an optical emitter 240 (coupled with the I/O board 225) to generate the first and second optical signals (from the first and second electrical signals) and transfers these signals to an optical receiver 260 of the system 250, through the buses 150 and 155. The optical receiver 260 is coupled with an I/O board 255 of the system 250, and upon receiving the first and the second optical signals, the optical receiver 260 provides the corresponding electrical signals to I/O modules 265 of the I/O board 255. The system 250 is further shown to include an optical emitter 270 (coupled with the I/O board 255) to transfer the first and second optical signals to an I/O board 285 of the system 280. An optical receiver 290 (coupled with the I/O board 285) of the system 280 receives the first and the second optical signals, and corresponding electrical signals are provided to I/O modules 295. The system 280 include the processing module 245 to check whether the actual information is received correctly at the I/O modules 295, and the actual information may be retrieved from the electrical signals at the I/O modules 295. As shown in FIG. 2, the system 280 further includes an optical emitter 298 for transferring the optical signals to a next system via the buses 150 and 155.

It should be understood that the I/O modules (235, 265 and 295) of the systems 220, 230 and 240 are coupled with or without optical transmission links. For instance, each of such I/O modules, among themselves, may communicate through a pair of copper links (such as wires), and the like. An exemplary representation of the copper wire 205 is shown in FIG. 2.

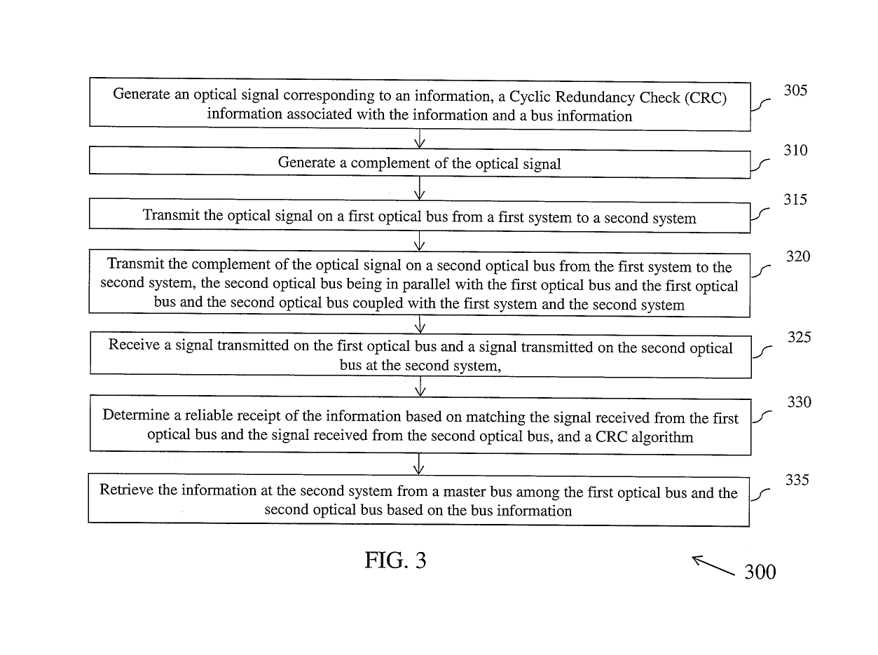

FIG. 3 is a flowchart depicting a method 300 for communication between a plurality of industrial systems, in accordance with an exemplary embodiment of the present disclosure. The method 300 depicted in the flow chart may be executed in a communication network such as communication networks 100 and/or 200 of FIGS. 1 and 2. Operations of the flowchart, and combinations of operation in the flowchart, may be implemented by various means, such as hardware, firmware, computing device, circuitry and/or other device associated with execution of software including one or more computer program instructions. To facilitate discussions of the method 300 of FIG. 3, certain operations are described herein as constituting distinct steps performed in a certain order. Such implementations are examples only and non-limiting in scope. Certain operation may be grouped together and performed in a single operation, and certain operations can be performed in an order that differs from the order employed in the examples set forth herein. Further, certain operations of the method 300 may be optional. Moreover, certain operations of the method 300 are performed in an automated fashion. These operations involve substantially no interaction with the user. Other operations of the methods 300 may be performed by in a manual fashion or semi-automatic fashion. These operations involve interaction with the user via one or more user interface presentations.

As shown in the FIG. 3, the operations 305-335 are performed between a pair of industrial systems. More specifically, the operations 305-320 are performed at a system that transfers the information and the operations 325-335 are performed at a system that receives the information.

At 305, the method 300 includes generating an optical signal comprising an information (for example, an actual information that is to be transferred) and a CRC information associated with the information. In an embodiment, optical signal may also comprise signal corresponding to a bus information. The bus information is associated with a master bus among a pair of buses and status of buses. At 310, the method 300 includes generating a complementary optical signal.

At 315, the method 300 includes transmitting the optical signal on a first optical bus from a first system to a second system of the plurality of industrial systems. An example of the first system may be the system 110, and an example of the second system may be the system 160. Examples of the first system may also be any of the systems 210, 220, 250 and 280, and the examples of the second system may also be any of the systems 220, 250 and 280. At 320, the method 300 includes transmitting the complementary optical signal on a second optical bus from the first system to the second system. The second optical bus is in parallel with the first optical bus, and both the buses are serial buses. Examples of the first and second optical buses may be the buses 150 and 155, as described in reference to FIGS. 1 and 2. The first optical bus and the second optical bus are coupled with I/O boards of the first system and the second system via optical receivers and/or optical emitters in the corresponding systems.

In some examples, the method 300 includes transferring a bus information alongwith the information and the CRC information. The bus information may be generated based on information of a master bus from the first optical bus and the second optical bus. In an example, a bus on which the information is used by the optical receiver may be considered as the master bus.

In some examples, the method 300 further includes receiving a signal transmitted on the first optical bus and a signal transmitted on the second optical bus at the second system, at 325. For instance, the method 300 includes receiving the optical signal from the first optical bus and receiving the complementary optical bus from the second optical bus. Further, at 330, the method 300 includes determining a reliable receipt of the information based on matching the signal received from the first optical bus and the signal received from the second optical bus, and also based on a CRC algorithm. For instance, reliability of the receipt of the information may be checked by determining the complementarity of signals received on both the buses. Further, the CRC information may be used to detect any error in the received signals. Further, at 335, using the bus information, the information may be retrieved at the second system from the master bus among the both buses.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

1. A communication network for transfer of information between industrial systems, the communication network comprising:
a plurality of industrial systems, each system of the plurality of industrial systems comprising:
at least one of an optical emitter and an optical receiver;
an Input/Output (I/O) board comprising at least one I/O module; and
a processing module coupled with the I/O board, the processing module and the I/O board configured, at least to, generate an optical signal corresponding to an information and a Cyclic Redundancy Check (CRC) information associated with the information;
a first optical bus coupled with the at least one of an optical emitter and an optical receiver of one or more pairs of systems of the plurality of industrial systems for transferring the optical signal between the one or more pairs of systems; and
a second optical bus coupled with the at least one of the optical emitter and the optical receiver of the one or more pairs of systems for transferring a complement of the optical signal between the one or more pairs of systems.

2. The communication network as claimed in claim 1, wherein the processing module comprises:
a CRC generator configured to generate the CRC information; and
a bus information module configured to the generate a bus information based on a master optical bus from the first optical bus and the second optical bus.

3. The communication network as claimed in claim 1, wherein the processing module is further configured to determine a reliable receipt of the information based on matching a signal received from the first optical bus and a signal received from the second optical bus, and a CRC algorithm.

4. The communication network as claimed in claim 1, wherein each of the first optical bus and the second optical bus is an optical fibre cable.

5. The communication network as claimed in claim 1, wherein each of the first optical bus and the second optical bus is a serial bus.

6. The communication network as claimed in claim 1, wherein the first optical bus and the second optical bus are arranged in a parallel configuration.

7. The communication network as claimed in claim 1, wherein at least one of the plurality of industrial systems comprises at least one memory module to store the information.

8. The communication network as claimed in claim 1, wherein I/O modules of each of the at least one I/O module are coupled through a copper wire.

9. A method for transfer of information between a plurality of industrial systems, the method comprising:
generating an optical signal corresponding to an information and a Cyclic Redundancy Check (CRC) information associated with the information;
generating a complement of the optical signal;
transmitting the optical signal on a first optical bus from a first system to a second system of the plurality of industrial systems; and
transmitting the complement of the optical signal on a second optical bus from the first system to the second system, the second optical bus being in parallel with the first optical bus and the first optical bus and the second optical bus coupled with an I/O board of the first system and an I/O board of the second system.

10. The method as claimed in claim 9, further comprising:
receiving a signal transmitted on the first optical bus and a signal transmitted on the second optical bus at the second system; and
determining a reliable receipt of the information based on matching the signal received from the first optical bus and the signal received from the second optical bus, and a CRC algorithm.

11. The method as claimed in claim 9, wherein the optical signal further corresponds to a bus information, the bus information generated based on a master optical bus from the first optical bus and the second optical bus.

12. The method as claimed in claim 11, further comprising retrieving the information from one of the optical signal and the complementary optical signal based on the bus information.

13. The method as claimed in claim 9, wherein each of the first optical bus and the second optical bus is an optical fibre cable.

14. The method as claimed in claim 9, wherein each of the first optical bus and the second optical bus is a serial bus.

15. The method as claimed in claim 9, wherein the first optical bus and the second optical bus are arranged in a parallel configuration.
